(19) United States
(12) Patent Application Publication
(10) Pub. No.: US 2026/0299344 A1
(43) Pub. Date: Oct. 1, 2026

(54) DISPLAY DEVICE AND ELECTRONIC MIRROR

(71) Applicant: Panasonic Automotive Systems Co., Ltd., Kanagawa (JP)

(72) Inventor: Hiroaki SATO, Kanagawa Ken (JP)

(73) Assignee: Panasonic Automotive Systems Co., Ltd., Kanagawa (JP)

(21) Appl. No.: 19/538,155

(22) Filed: Feb. 12, 2026

(30) Foreign Application Priority Data
Mar. 31, 2025 (JP) 2025-059489

(51) Int. Cl. G02F 1/1333; F21V 8/00; G02F 1/137

(52) U.S. Cl. CPC G02F 1/133317; G02B 6/0068; G02F 1/137; G02F 2203/01; G02F 2203/02

(57) ABSTRACT

A display device according to the present disclosure includes a middle frame and a rear frame. The middle frame supports a front frame on a side toward a display panel from a backlight. The front frame forms a frame portion. The rear frame supports the backlight from a side opposite to the display panel. An end portion of the middle frame and an end portion of the rear frame in a width direction of the frame portion formed by the front frame are arranged so as not to overlap in the width direction of the frame portion.

### CROSS-REFERENCE TO RELATED APPLICATIONS

This application is based upon and claims the benefit of priority from Japanese Patent Application No. 2025-059489, filed on Mar. 31, 2025, the entire contents of which are incorporated herein by reference.

### FIELD

The present disclosure relates to a display device and an electronic mirror.

### BACKGROUND

A display device such as an electronic mirror has a display area inside a frame area on a front surface. The display device displays an image in the display area on the front surface in a display mode and causes the display area on the front surface to function as a mirror in the mirror mode.

A related technology is described in U.S. Pat. No. 10,850,667 B.

It is necessary to further narrow a frame of an electronic mirror from the viewpoint of improving the design and securing the front view.

In the display device, from the viewpoint of miniaturization and/or weight reduction, frame narrowing of narrowing the width of a frame area is desired.

The present disclosure provides a display device and an electronic mirror that can achieve frame narrowing.

### SUMMARY

A display device according to the present disclosure includes a middle frame and a rear frame. The middle frame supports a front frame on a side toward a display panel from a backlight. The front frame forms a frame portion. The rear frame supports the backlight from a side opposite to the display panel. An end portion of the middle frame and an end portion of the rear frame in a width direction of the frame portion formed by the front frame are arranged so as not to overlap in the width direction of the frame portion.

### BRIEF DESCRIPTION OF THE DRAWINGS

FIG. 1 is an explanatory view of a vehicle equipped with an electronic mirror system;

FIG. 2 is a front view of a display device;

FIG. 3 is a partial cross-sectional view taken along line A-A of FIG. 2;

FIG. 4 is a partial cross-sectional view taken along line B-B of FIG. 2 of a first aspect;

FIGS. 5A and 5B are explanatory diagrams of another principle of frame narrowing; and

FIG. 6 is a partial cross-sectional view taken along line B-B of FIG. 2 of a second aspect.

### DETAILED DESCRIPTION

Hereinafter, an embodiment of a display device according to the present disclosure is described with reference to the drawings.

Meanwhile, it is considered that an electronic mirror as a display device is configured so that a rear frame, a middle frame, a metal (liquid crystal) bezel, and a mirror front frame of a backlight are arranged in this order in a cross section of a frame.

In such a configuration, there are many frames, and further frame narrowing is limited.

In addition, when a portion of the backlight where the frame is hidden is reduced, luminance unevenness of an LED arranged at an edge is visually recognized, and countermeasures are required.

### Embodiment

The display device according to the embodiment is, for example, an electronic mirror. The display device according to the embodiment has a frame area at an edge portion on a front surface but is devised to narrow the width of the frame area. Reducing the width of the frame area may be referred to as frame narrowing.

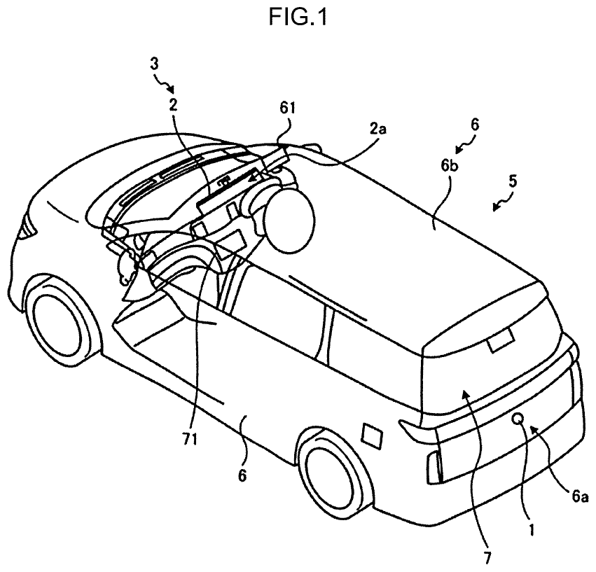

FIG. 1 is an explanatory view of a vehicle equipped with an electronic mirror system.

An electronic mirror system 3 includes an imaging device 1 and a display device 2.

The imaging device 1 is an vehicle-mounted camera mounted on a vehicle 5 and is installed outside or inside a vehicle body 6. The imaging device 1 may be installed at a rear end portion of the vehicle body 6 and applied to a rear electronic mirror, may be installed at an end portion near a door of the vehicle body 6 and applied to a side electronic mirror, or may be installed at a front end portion of the vehicle body 6 and applied to a front electronic mirror.

The display device 2 is disposed, for example, in a vehicle interior 7 of the vehicle 5.

The display device 2 is, for example, an electronic mirror, has a front surface 2a, and can display an image acquired by the imaging device 1 on the front surface 2a.

The display device 2 is configured to be switchable between a display mode and a mirror mode. The display mode is a mode in which the display device 2 functions as a display that displays an image captured by the imaging device 1. The mirror mode is a mode in which the display device 2 functions as a mirror.

When the display device 2 is configured as an electronic mirror for rear visual recognition, the display device 2 may be mounted in the form of a rearview mirror, or the front surface 2a may face the vehicle interior 7, and the shape of the front surface 2a may be the shape of a mirror surface of the rearview mirror.

Also, when the display device 2 is configured as an electronic mirror for side visual recognition, the display device 2 may be mounted in the form of a door mirror (for example, a door mirror 61), or the front surface 2a may face a rear side of the vehicle body 6, and the shape of the front surface 2a may be the shape of a mirror surface of the door mirror.

Also, when the display device 2 is configured as an electronic mirror for front visual recognition, the display device 2 may be mounted in the form of a vehicle-mounted display device, the front surface 2a may face the vehicle interior 7, and the shape of the front surface 2a may be the shape of a display unit of the display device.

FIG. 1 illustrates a configuration in which the imaging device 1 is installed in a rear end portion 6a of the vehicle body 6, and the display device 2 is applied to an electronic mirror for rear visual recognition. The electronic mirror for rear visual recognition is also called an electronic rearview mirror. The imaging device 1 acquires an image of the rear side of the vehicle body. The display device 2 can display an image of the rear side of the vehicle body captured by the imaging device 1.

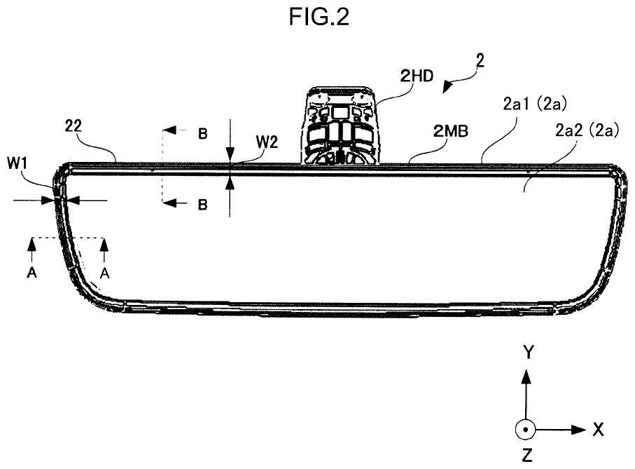

FIG. 2 is a front view of the display device.

In the following description, a direction perpendicular to the front surface 2a of the display device 2 is defined as a Z direction, and two directions orthogonal to each other in the front surface 2a are defined as an X direction and a Y direction.

The display device 2 includes a display device main body 2MB and a holder 2HD.

The holder 2HD is for mounting the display device 2 in the vehicle interior 7 and supports the display device main body 2MB so that an orientation of the display device main body 2A can be changed.

The front surface 2a of the display device main body 2MB has, for example, a rectangular shape with rounded corners in the XY plane view. The front surface 2a has a frame area 2a1 and a display area 2a2. The frame area 2a1 is an edge on the front surface 2a and is a portion called a bezel.

The display area 2a2 is a portion inside the frame area 2a1 on the front surface 2a.

The display device 2 displays an image in the display area 2a2 on the front surface 2a in a display mode and causes the display area 2a2 on the front surface 2a to function as a mirror in the mirror mode.

In this case, the display device 2 can have a variable reflectance mirror (VRM) function. When the display device 2 has the VRM function, the display device 2 may change a reflectance of the display area 2a2 according to a luminance or the like of the reflected image in the mirror mode. For example, if it is assumed that the reflectance of the display area 2a2 is maintained at a first reflectance RR1 when the luminance of the reflected image is less than a predetermined value in the mirror mode, the display device 2 can reduce the reflectance of the display area 2a2 to a second reflectance RR2 (<RR1) when the luminance of the reflected image is equal to or greater than the predetermined value.

More specifically, the case where the luminance of the reflected image is equal to or higher than a predetermined luminance is a case where a headlight of a following vehicle is reflected at a luminance equal to or higher than the predetermined luminance or a case where sunlight is reflected at a luminance equal to or higher than the predetermined luminance in the rear image. Consequently, the display device 2 can implement automatic anti-glare by the VRM in the mirror mode.

On the front surface 2a, the frame area 2a1 has an approximate width W1 in a portion extending in the Y direction and an approximate width W2 in a portion extending in the X direction. The width W1 and the width W2 may be equal or different from each other.

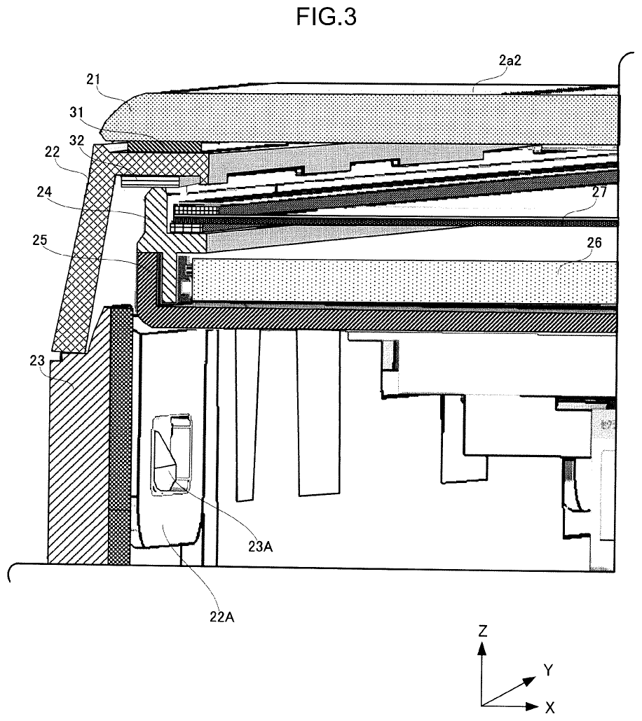

FIG. 3 is a partial cross-sectional view taken along line A-A of FIG. 2.

As illustrated in FIG. 3, the display device 2 includes a front surface light-transmitting panel 21, a front frame 22, a rear case 23, a middle frame 24, a rear frame 25, a light guide plate 26, a liquid crystal display panel 27, and an LED 28. The light guide plate 26 and the LED 28 may be collectively referred to as a light guide unit (light guider).

Here, the liquid crystal display panel 27 functions as a display panel.

The front surface light-transmitting panel 21 extends in a plate shape in the X and Y directions and has a substantially rectangular shape with the X direction as a longitudinal direction. The front surface light-transmitting panel 21 may be formed with inorganic glass containing SiO₂ or may be formed with organic glass including transparent resin such as polymethyl methacrylate (PMMA) or polycarbonate (PC). The front surface light-transmitting panel 21 is also called a cover panel and protects the display device 2 from an external impact or the like.

A mirror panel (not illustrated) is disposed on a −Z-side surface of the front surface light-transmitting panel 21. The mirror panel configures a so-called half mirror and covers the entire display surface of the liquid crystal display panel 27 described below. Therefore, when light of the backlight is not incident on the liquid crystal display panel 27 from the light guide plate 26 described below, the display device 2 functions as a normal mirror.

Since the mirror panel is not adhered (bonded) to the liquid crystal display panel 27, even when the mirror function is deteriorated for some reason, it is not necessary to integrally replace the mirror panel with the liquid crystal display panel 27, and the mirror panel can be easily replaced.

The front frame 22 is formed with resin, and the front surface light-transmitting panel 21 is attached to the front frame with an adhesive 31 such as a double-sided tape to support the front surface light-transmitting panel 21.

The rear case 23 is formed with resin, configures a spigot structure with the front frame 22, and configures a housing of the display device 2 in combination with the front frame 22.

In this case, as illustrated in FIG. 3, a recess 22A that configures the spigot structure is disposed in an end portion of the front frame 22 in the-Z direction with respect to the rear frame 25 and is inserted into the rear case 23 to be engaged with and integrated with a protrusion 23A disposed on the rear case 23.

In this manner, since the recess 22A and the protrusion 23A that configure the spigot structure are disposed at positions that do not affect the dimensions of the frame portion, the frame narrowing can be easily achieved.

The middle frame 24 supports the front frame 22 by receiving the front frame 22 from a back surface side (−Z direction side) via a pad 32. In this case, the pad 32 is disposed on the entire circumference along a peripheral edge of the front frame 22, and the front frame is received via the pad 32 to have a sealing function as a countermeasure against intrusion of a foreign matter. Furthermore, when the front frame is received via the pad 32, the temperature of the front frame 22, deformation at the time of manual operation by the user, or the like is absorbed so that suppression of the occurrence of squeaking sound is achieved.

The middle frame 24 is formed with white resin in order to increase reflectance and light scattering efficiency.

In this case, the light of the backlight is irregularly reflected by the middle frame 24 and diffused, thereby contributing to uniformity of the light of the backlight.

The rear frame 25 supports the light guide plate 26 from the back surface side (−Z direction side). As a result, the light of the backlight which is leaked from the back surface side (−Z direction side) of the light guide plate 26 is reflected by the rear frame 25, guided to a front surface side (+Z direction side) of the light guide plate 26, and can be illuminated brighter toward the liquid crystal display panel 27.

Also, the rear frame 25 is supported from the back surface side (−Z direction side) of the front frame 22.

The light guide plate 26 is disposed at a position facing the plurality of LEDs 28 arranged on a flexible printed circuit board (FPC) installed on the rear frame 25. The LED 28 is disposed on a side of the rear frame 25 in the +Y direction. The light of the backlight is transmitted in the light guide plate 26 to illuminate the liquid crystal display panel 27 from the back surface side.

In this case, since the thickness of the light guide plate 26 is made thinner than that of a light guide plate in the related art, the optical path length in the light guide plate 26 is effectively shortened, so that a bright display screen with less attenuation can be obtained.

In this case, a large number of LEDs 28 for illumination are arranged in a manner of being close to each other. By compensating for a dark portion where the light of the backlight is not emitted in the vicinity of each LED with the light of the backlight of the adjacently disposed LED, illumination unevenness due to the light of the backlight is less likely to occur, and it is possible to contribute to suppression of the width (widths W1 and W2) of the frame area 2a1.

The liquid crystal display panel 27 is, for example, a transmissive liquid crystal display panel having a configuration in which an IPS-type liquid crystal material is sealed between a pair of transparent substrates that are disposed apart from each other in the Z direction and extend in the XY direction. When the light of the backlight is incident from the back surface side (−Z direction side), an image is displayed in a visible state.

Also, the liquid crystal display panel 27 of the present embodiment uses a metal bezel-less liquid crystal display unit in order to achieve frame narrowing. When the liquid crystal display unit with the metal bezel is used, the metal bezel surrounds four sides of the rear frame and supports the front frame. In the present embodiment, frame narrowing is achieved by not using the metal bezel.

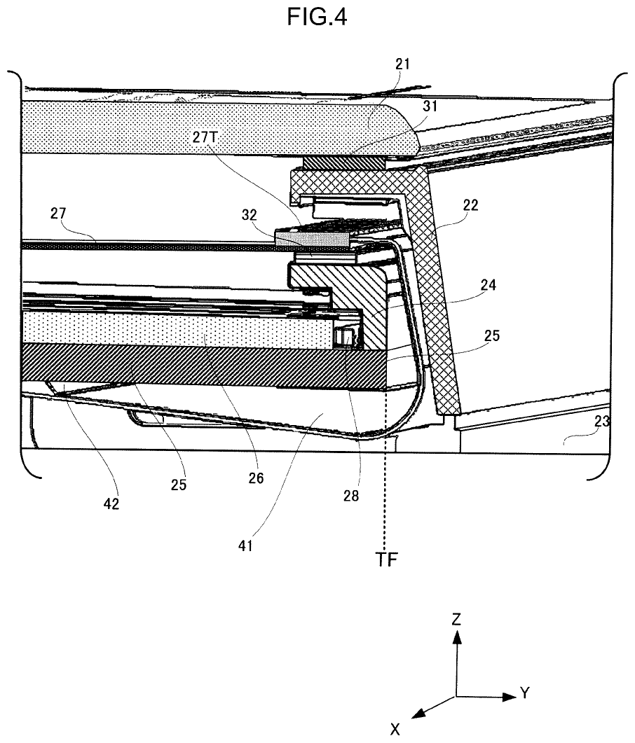

FIG. 4 is a partial cross-sectional view taken along line B-B of FIG. 2 of a first aspect.

In FIG. 4, portions similar to those in FIG. 3 are denoted by the same reference numerals.

As illustrated in FIG. 4, a connector terminal 27T for supplying a control signal and drive power to the liquid crystal display panel 27 is connected to an upper end portion of the display device 2.

A flexible printed circuit board (FPC) 41 is connected to the connector terminal 27T.

The flexible printed circuit board 41 is positioned on the back surface side (−Z-axis direction side) of the rear frame 25 via a gap between the middle frame 24 and the rear frame 25, and the front frame 22.

Also, a chip on film (COF) configuration is adopted in which a driver IC 42 for controlling the liquid crystal display panel 27 is disposed on the back surface side (−Z-axis direction side) of the rear frame 25. As a result, as compared with the technique in the related art in which the driver IC 42 is disposed on a glass substrate configuring the liquid crystal display panel 27, an area of a non-display screen portion of the liquid crystal display panel 27 is reduced, and the width W2 of the frame portion is reduced to achieve frame narrowing.

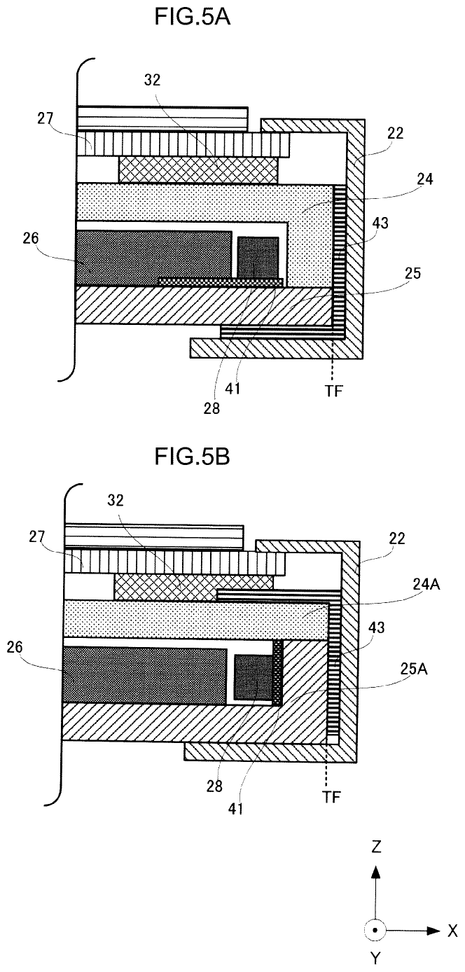

FIGS. 5A and 5B are explanatory diagrams of another principle of frame narrowing.

In FIGS. 5A and 5B, the flexible printed circuit board 41 is not illustrated for easy understanding.

Furthermore, in addition to the adoption of the COF configuration, as illustrated in FIG. 4, in +X direction end portions TF of the middle frame 24 and the rear frame 25, a +X direction end surface of the middle frame 24 and a +X direction end surface of the rear frame 25 are substantially at the same position.

As illustrated in FIG. 5A, the middle frame 24 having an L-shaped cross section is configured to be supported in the +Z direction of the rear frame 25 having an I-shaped cross section.

Here, in FIG. 5A, the LED 28 is disposed along the X direction on a side (corresponding to a first side) positioned in the +Y direction on an upper surface of the rear frame 25.

According to this configuration, the +X direction end surface of the middle frame 24 does not abut on the rear frame 25, the +X direction end surface of the rear frame 25 does not abut on the middle frame 24, and the position of the +X direction end portion TF can be set to the position on the front side in the +X direction in FIG. 5A as compared with the abutting cases.

That is, the right end surface of the middle frame 24 in FIG. 5A and the right end surface of the rear frame 25 in FIG. 5A are set to the same position.

Meanwhile, since mechanical strength is reduced as compared with a technique in the related art in which one of the end surfaces abuts on the other, a reinforcing tape 43 is attached so as to cover a portion of the +X direction end surfaces of the middle frame 24 and the rear frame 25 and a portion of the −Z direction end surface of the rear frame 25 to enhance the strength.

That is, as illustrated in the schematic diagram of FIG. 5A, the middle frame 24 and the rear frame 25 do not have a portion arranged to overlap along the +X direction unlike in the related art and are reinforced by the reinforcing tape, so that the strength can be maintained while reducing the width W2 of the frame portion to achieve frame narrowing.

Also, as illustrated in FIG. 5B, the middle frame 24 having an I-shaped cross section is configured to be supported in the +Z direction end surface of the rear frame 25 having an L-shaped cross section.

Here, in FIG. 5B, the LED 28 is disposed on a left end surface (corresponding to the first side) of a portion erected in the +Z direction of the rear frame 25.

Also with this configuration, the +X direction end surface of the middle frame 24 does not abut on the rear frame 25, the +X direction end surface of the rear frame 25 does not abut on the middle frame 24, and the position of the +X direction end portion TF can be set to the position on the front side in the +X direction in FIG. 5B as compared with the abutting cases.

That is, the right end surface of the middle frame 24 in FIG. 5B and the right end surface of the rear frame 25 in FIG. 5B are at the same position.

Therefore, also in the configuration illustrated in the schematic diagram of FIG. 5B, the middle frame 24 and the rear frame 25 do not have a portion arranged to overlap along the +X direction unlike in the related art and are reinforced by the reinforcing tape, so that the strength can be maintained while reducing the width W2 of the frame portion to achieve frame narrowing.

That is, in any configuration, the end portion of the side of the rear frame 25 on which the LED 28 is disposed and the end portion of the side corresponding to the middle frame 24 are disposed so as not to overlap.

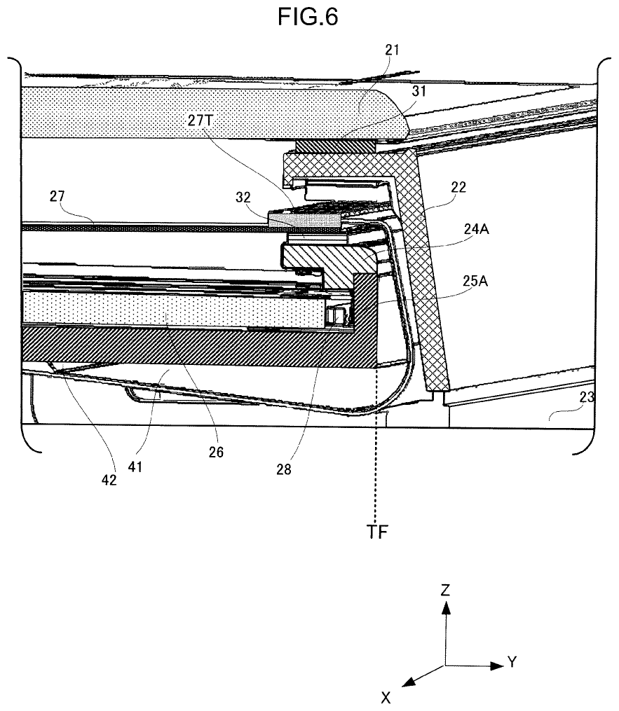

FIG. 6 is a partial cross-sectional view taken along line B-B of FIG. 2 of a second aspect.

In FIG. 6, portions similar to those in FIG. 3 are denoted by the same reference numerals.

As illustrated in FIG. 6, the connector terminal 27T for supplying a control signal and drive power to the liquid crystal display panel 27 is connected to an upper end portion of the display device 2.

A flexible printed circuit board (FPC) 41 is connected to the connector terminal 27T.

The flexible printed circuit board 41 is positioned on the back surface side (−Z-axis direction side) of the rear frame 25 via a gap between the middle frame 24 and the rear frame 25, and the front frame 22.

A chip on film (COF) configuration in which the driver IC 42 for controlling the liquid crystal display panel 27 is disposed is adopted on the back surface side (−Z-axis direction side) of the rear frame 25, and frame narrowing is achieved by reducing the area of the non-display screen portion of the liquid crystal display panel 27 and reducing the width W2 of the frame portion, as compared with the technique in the related art in which the driver IC 42 is disposed on the glass substrate configuring the liquid crystal display panel 27.

Also, as illustrated in FIG. 5B, a middle frame 24A having an I-shaped cross section is configured to abut on a rear frame 25A having an L-shaped cross section in the +Z direction.

According to this configuration, the +X direction end surface of the middle frame 24 does not abut on the rear frame 25, the +X direction end surface of the rear frame 25 does not abut on the middle frame 24, and the position of the +X direction end portion TF can be set to the position on the front side in the +X direction in FIG. 5B.

Meanwhile, in order to avoid reduction of the mechanical strength as compared with a technique in the related art in which one of the end surfaces abuts on the other, the reinforcing tape 43 is attached so as to cover a portion of the +X direction end surfaces of the middle frame 24 and the rear frame 25 and a portion of the +Z direction end surface of the middle frame 24 to enhance the strength.

That is, as illustrated in the schematic diagram of FIG. 5B, the middle frame 24 and the rear frame 25 do not have a portion arranged to overlap along the +X direction unlike in the related art and are reinforced by the reinforcing tape, so that the strength can be maintained while reducing the width W2 of the frame portion to achieve frame narrowing.

As described above, according to the embodiment, even if the area of the frame portion is reduced, the display is not affected. Therefore, the width W1 and the width W2 of the frame portion can be narrowed to achieve frame narrowing.

According to the display device and the electronic mirror of the present disclosure, frame narrowing can be achieved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display device comprising:
a middle frame supporting a front frame on a side toward a display panel from a backlight, the front frame forming a frame portion; and
a rear frame supporting the backlight from a side opposite to the display panel,
wherein an end portion of the middle frame and an end portion of the rear frame in a width direction of the frame portion formed by the front frame are arranged so as not to overlap in the width direction of the frame portion.

2. The display device according to claim 1, wherein
the backlight comprises a plurality of LEDs,
the plurality of LEDs are disposed at a first side of the rear frame, and
the end portion of the rear frame at the first side and the end portion of the middle frame at a side corresponding to the first side are arranged so as not to overlap in the width direction of the frame portion.

3. The display device according to claim 1,
wherein a reinforcing tape is attached to an end surface of the middle frame and an end surface of the rear frame in the width direction of the frame portion so that the middle frame and the rear frame are integrated.

4. The display device according to claim 3, wherein
the backlight includes a plurality of LEDs,
the plurality of LEDs are disposed on a first side of the rear frame, and
the reinforcing tape is attached to an end surface of the rear frame at the first side and an end surface of the middle frame at a side corresponding to the first side.

5. The display device according to claim 1, wherein
a flexible printed circuit board is connected to the display panel, and
the flexible printed circuit board is routed to a back surface side of a light guider configured to transmit light of the backlight, and a driver IC of the display panel is disposed in a chip on film configuration in a portion of the flexible printed circuit board on the back surface side of the light guider.

6. The display device according to claim 1,
wherein the middle frame is formed with white resin to reflect light of the backlight.

7. The display device according to claim 5,
wherein the light guider comprises:
a light guide plate; and
a plurality of LEDs arranged to face an end surface of the light guide plate in a width direction.

8. The display device according to claim 1, further comprising
a rear case forming a housing in combination with the front frame,
wherein the front frame and the rear case are integrated by a spigot structure.

9. The display device according to claim 1,
wherein a metal bezel-less display panel is used as the display panel.

10. The display device according to claim 8,
wherein the spigot structure is disposed in an end portion of the front frame located rearward of the front frame.

11. The display device according to claim 1,
the display panel comprises a transmissive liquid crystal display panel.

12. The display device according to claim 1,
the end portion of the middle frame extends in a direction perpendicular to the width direction of the frame portion and supported on the end portion of the rear frame.

13. The display device according to claim 1,
the end portion of the middle frame is supported on an end surface of the end portion of the rear frame extending in a direction perpendicular to the width direction of the frame portion

14. An electronic mirror comprising
the display device according to claim 1,
wherein the display device is configured to be switched between a display mode and a mirror mode, the display device being configured to display an image in the display mode and function as a mirror in the mirror mode.

15. The electronic mirror according to claim 14,
wherein the display device is coupled to a camera mounted on a vehicle, and the image displayed in the display mode comprises an image captured by the camera.
